(19) United States
(12) Patent Application Publication
(10) Pub. No.: US 2009/0263617 A1
(43) Pub. Date: Oct. 22, 2009

(54) PANEL CONTAINING BAMBOO

(75) Inventors: Nian-hua Ou, Dacula, GA (US); Brian Christopher Gerello, Midland, NC (US)

Correspondence Address: Gardner Groff Greenwald & Villanueva, PC, 2018 Powers Ferry Road, Suite 800, Atlanta, GA, 30339, US

(73) Assignee: HUBER ENGINEERED WOODS LLC, Charlotte, NC (US)

(21) Appl. No.: 12/405,110

(22) Filed: Mar. 16, 2009

Related U.S. Application Data
(63) Continuation-in-part of application No. 12/259,780, filed on Oct. 28, 2008.
Application No. 12/259,780 is a continuation of application No. 11/216,655, filed on Aug. 31, 2005, now Pat. No. 7,459,206.
Application No. 11/216,655 is a continuation-in-part of application No. 11/215,906, filed on Aug. 31, 2005.
Application No. 11/215,906 is a continuation-in-part of application No. 11/216,654, filed on Aug. 31, 2005, now abandoned.
Application No. 11/216,654 is a continuation-in-part of application No. 11/240,067, filed on Sep. 30, 2005, now abandoned.
Application No. 11/240,067 is a continuation-in-part of application No. 11/285,452, filed on Nov. 22, 2005, now abandoned.
Application No. 11/285,452 is a continuation-in-part of application No. 11/290,660, filed on Nov. 30, 2005, now abandoned.

(51) Int. Cl. B32B 21/14; B32B 21/02; B32B 5/12

(52) U.S. Cl. 428/106; 428/220

(57) ABSTRACT

A multi-layered composite wood panel including a core layer, a first surface layer and a second surface layer. The core layer is formed from wood flakes and has a top surface and a bottom surface. The first surface layer is adhered to the top surface of the core layer and includes strands of woven bamboo. The second surface layer is adhered to the bottom surface of the core layer and includes strands of woven bamboo. The core layer, first surface layer and second surface layer are bound together to form a substantially rectangular plane having a thickness of between about 0.25 inches and about 2.0 inches.

### CROSS REFERENCE TO RELATED APPLICATION

This application is a continuation-in-part of the following: pending U.S. patent application Ser. No. 12/259,780, which was filed on Oct. 28, 2008, and is entitled “PANEL CONTAINING HIGHLY-CUTINIZED BAMBOO FLAKES”, which is a continuation of issued U.S. patent application Ser. No. 11/216,655, now U.S. Pat. No. 7,459,206, that was filed on Aug. 31, 2005; pending U.S. patent application Ser. No. 11/215,906, filed Aug. 31, 2005, entitled “WOOD PANEL CONTAINING INNER CULM FLAKES”; pending U.S. patent application Ser. No. 11/216,654, filed Aug. 31, 2005, entitled “PANEL CONTAINING BAMBOO”; pending U.S. patent application Ser. No. 11/240,067, filed Sep. 30, 2005, entitled “PANEL CONTAINING BAMBOO AND FUNGICIDE”; pending U.S. patent application Ser. No. 11/285,452, filed Nov. 22, 2005, entitled “PANEL CONTAINING BAMBOO”; and pending U.S. patent application Ser. No. 11/290,660, filed Nov. 30, 2005, entitled “PANEL CONTAINING BAMBOO”. The disclosure of these applications are hereby incorporated by reference in their entirety for all purposes.

### BACKGROUND OF THE INVENTION

Wood is a common material that has been used to construct a variety of different objects of different sizes and for different functions. It remains in wide use to this present day as one of the most widely-used structural materials, even after the development of several new species of composite materials, because of its excellent strength and stiffness, pleasing aesthetics, good insulation properties and easy workability.

However, in recent years the cost of solid timber wood has increased dramatically as its supply shrinks due to the gradual depletion of old-growth and virgin forests. Such wood is particularly expensive to manufacture products from, because typically less than half of harvested timber wood is converted to natural solid wood lumber, the remainder being discarded as scrap.

Accordingly, because of both the cost of high-grade timber wood as well as a heightened emphasis on conserving natural resources, wood-based and other lignocellulosic-based alternatives to natural solid wood lumber have been developed that make more efficient use of harvested wood and reduce the amount of wood discarded as scrap. Plywood, particle board and oriented strand board (“OSB”) are examples of engineered, composite alternatives to natural solid wood lumber that have replaced natural solid wood lumber in many structural applications in the last seventy-five years.

These wood-based composites not only use the available supply of timber wood more efficiently, but they can also be formed from lower-grade wood species that are less commonly used.

Bamboo is a lignocellulosic material widely used throughout Asia as a building material because of its high strength, durability and excellent dimensional stability, as well as its ready supply and rapid replenishment—bamboo grows very rapidly, reaching full maturity within 2 to 6 years, while even the fastest growing wood tree species take as long as 15 to 30 years to grow to full maturity.

However, in addition to these advantages, bamboo also has a number of disadvantages. Since bamboo is hollow, it also cannot be processed into solid lumber board or planks.

And, not only is it impossible to make solid lumber from, but bamboo can also not be processed by the conventional techniques used to make traditional wood composite materials. For example, it is difficult to make plywood from bamboo because the bamboo culms are too thin to cut plywood veneers from. Nor has bamboo previously been successfully processed by techniques used to make strand composite wood materials (which are composite materials made from resin-coated strands given a preferred orientation and deposited in that orientation on an underpassing conveyor belt).

Despite these disadvantages, bamboo's ready supply and excellent performance characteristics have enticed manufacturers to develop techniques to make wood composite materials out of bamboo. For example, composite bamboo structural panels may be made by hand-cutting bamboo strands from the outer part or surface of a bamboo culm, and then weaving (again, typically by hand) the strands into mats. These hand-cut, hand-woven bamboo mats are then stacked together along with several other similar mats, and the mats then pressed together under high temperature.

The problem with this method of manufacture of the bamboo boards is that it is time consuming and labor-intensive; the steps of cutting the bamboo strips and then weaving the bamboo strips into the form of a mat take a significant amount of time. And, not only are these processes time consuming, but they can lead to significant defects in the final board product. For example, internal gaps created by the layering of several of the mats on top of another can result in the production of holes or other defects in the board that can lead to failure. Additionally, bonding two woven bamboo mats together involves bonding together two mating surfaces, which is an additional source for defects. Yet another disadvantage of the aforementioned processes is that because they are composed of large numbers of bamboo layers, they are require very high doses of resin per layer, which adds greatly to the price of the product during periods of high petroleum prices.

Given the foregoing, there is a need in the art for structural bamboo panels that are either partly or completely composed of bamboo, have fewer defects, do not require a lengthy manufacturing process, and consume a smaller amount of petroleum-based products.

### BRIEF SUMMARY OF THE INVENTION

In one aspect, the present invention relates to an improvement to a traditional 4 foot by 8 foot composite wood panel having a thickness between about 0.25 inches and about 2.0 inches and being formed from flakes of compressed wood and having top and bottom surfaces. The improvement includes an upper surface layer and a bottom surface layer attached to the composite wood panel. The upper surface layer is attached to the top surface of the composite wood panel and is formed from one or more plies of bamboo strands. The strands have a thickness of between about 0.0625 inches to about 0.5 inches. The lower surface layer is attached to the bottom surface of the composite wood panel and is formed from one or more plies of bamboo strands. The strands also have a thickness of between about 0.0625 inches and about 0.5 inches.

In a second aspect, the present invention relates to a composite wood panel having the dimensions of substantially 4 feet by 8 feet. The panel includes an upper surface layer including bamboo strands. The panel also includes a lower surface layer including bamboo strands. Still further, the panel includes a core layer consisting of wood strands. The panel contains about 25% to about 75% bamboo strands, and about 75% to about 25% wood strands and is between about 0.25 inches to about 2.0 inches thick.

In a third aspect, the present invention relates to a composite wood panel having a first layer and a second layer. The first layer is formed from woven bamboo sheets, the bamboo sheets being substantially planar and being formed from strands of bamboo woven together and coated with isocyanate resin. The second layer is adhered to the first layer and is formed from strands of hard and/or soft wood and the second layer is substantially planar. The first and second layers are adhered together with an adhesive.

In a fourth aspect, the present invention relates to a multi-layered composite panel including a first ply of bamboo flakes, a second ply of wood flakes, and a third ply of bamboo flakes. The first ply of bamboo flakes is substantially oriented in a first direction. The second ply of wood flakes is substantially oriented in a second direction that is substantially perpendicular to the first direction. The second ply of wood flakes rests on top of the first ply. The third ply of bamboo flakes is substantially oriented in the first direction and rests on top of the second ply. The first, second, and third plies are coated in one or more polymeric resins to serve as a binder, the binder being in the range of about 2 wt % to about 15 wt %.

In another aspect, the present invention relates to a multi-layered composite wood panel including a core layer, a first surface layer and a second surface layer. The core layer is formed from wood flakes and has a top surface and a bottom surface. The first surface layer is adhered to the top surface of the core layer and includes strands of woven bamboo. The second surface layer is adhered to the bottom surface of the core layer and includes strands of woven bamboo. The core layer, first surface layer and second surface layer are bound together to form a substantially rectangular plane having a thickness of between about 0.25 inches and about 2.0 inches.

In still another aspect, the present invention relates to a method of producing an improved wood composite panel having improved strength characteristics over conventional wood composite panels. The method includes the steps of: (1) cutting strands of bamboo in the longitudinal direction from a bamboo culm; (2) weaving the strands of bamboo into one or more woven bamboo sheets; (3) coating the one or more bamboo sheets with isocyanate resin; and (4) adhering the one or more bamboo sheets to a wood composite component core formed from hard and/or soft woods. The improved panel is between about 0.25 inches and about 2.0 inches thick.

### BRIEF DESCRIPTION OF THE DRAWING FIGURES

FIG. 1 is a schematic representation of a panel according to an example embodiment of the present invention.

FIG. 2 is an exploded schematic representation of a panel according to another example embodiment of the present invention.

### DETAILED DESCRIPTION OF THE INVENTION

All parts, percentages, and ratios used herein are expressed by weight unless otherwise specified. All documents cited herein are incorporated by reference.

As used herein, “lignocellulosic material” is intended to mean a cellular structure, having cell walls composed of cellulose and hemicellulose fibers bonded together by lignin polymer. Wood is a species of lignocellulosic material.

By “wood composite material” or “wood composite component” it is meant a composite material that comprises lignocellulosic material and one or more other additives, such as adhesives or waxes. Non-limiting examples of wood composite materials include structural composite lumber (“SCL”), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6th Edition, which is hereby incorporated by reference.

The following describes example embodiments of the present invention, which provides a wood panel comprising a wood composite component and one or more bamboo layers. The wood composite material forms the interior of the panel, while the one or more bamboo layers are formed from woven sheets of bamboo. This allows the manufacture of wood panels, which have the tough, durable surface of bamboo without requiring a very large number of woven bamboo sheets—instead, a smaller number of woven bamboo sheets are affixed on to the wood composite core. This panel addresses the aforementioned drawbacks of structural bamboo panels: the panel has the durability of bamboo; specifically, it has the durability of bamboo but is without the internal surface gaps and other defects that can compromise performance. Additionally, reducing the number of bamboo sheets shortens the manufacturing process and results in a panel product that is a less intensive user of petroleum-based products.

The following also describes example embodiments of the present invention, which provides a SCL or wood panel comprising bamboo strands cut from the outer portion of the bamboo culm. SCL products include laminated veneer lumber (“LVL”), parallel strand lumber (“PSL”), laminated strand lumber (“LSL”), and oriented strand lumbers (“OSL”), which will be described in greater detail below.

Additionally, the following describes example embodiments of the present invention, which provide a composite wood panel comprising bamboo strands cut from the inner portion of the bamboo culm. Forming a product from strands cut from the inner portion of the bamboo culm results in a wood panel having excellent strength and durability characteristics.

Still further, the following describes example embodiments of the present invention, which provides a composite panel comprising a mixture of bamboo strands and strands from one or more wood materials. The composite panel is prepared by mixing bamboo strands with the conventional wood strands. As discussed in greater detail below, the bamboo strands may be concentrated only in surface layers where they make a more direct contribution to the strength of the material or they can be spread throughout the panel as desired. Thus, the composite material of the present invention has many advantages of the bamboo material, such as strength, while also being lighter and more resistant to water damage and water-caused swelling.

Like wood materials, bamboo's basic components are cellulose fibers bonded together by lignin polymer, but bamboo differs from other wood materials in the organization and morphology of its constituent cells. Generally, most strength characteristics of bamboo (tensile strength, flexural strength and rigidity) are greatest in the longitudinal direction of the bamboo and the bamboo fibers. This is due to the relatively small micro-fibular angle of the cellulose fibers in the longitudinal direction. The hardness of the bamboo culm itself is dependent on the density of bamboo fibers bundles and their manner of separation. The percentage of fibers is not consistent either in the longitudinal direction of the bamboo culm or in a cross section of the culm. In the longitudinal direction, the density of fibers increases from the bottom of the culm to its top, while the density of fibers in the bamboo culm cross-section is highest closer to the outer surface and decreases going deeper into the core of the material. Moreover, the strength and hardness of the outer portion of the bamboo culm is increased by the presence of a silica-deposited, cutinized layer coated with wax, which covers the surface of the outer part of the culm. Thus, the bamboo on or near the outer surface of the culm (that portion of the culm that is within about 2 mm of the outer diameter of the bamboo culm) has superior strength characteristics, and in most processes for using bamboo fibers, these improved strength properties are not exploited because the outer portion of the culm is stripped off. Unlike previous techniques for using bamboo, example embodiments of the present invention incorporate the cutinized layer—and thus the high strength properties of the bamboo are utilized. Of course, the inner portion of the bamboo culm (that portion of the culm that is more than about 2 mm from the outer diameter of the bamboo culm) has been discovered to be stiffer and stronger than the fibers of most wood species and comprises a large percentage of a typical bamboo culm. Therefore, other example embodiments of the present invention incorporate the inner portion of the bamboo culm—either exclusively or in conjunction with the outer portion of the bamboo culm—to form wood composite materials according to the present invention.

Generally, the cellulose fibers found in both the inner and outer portion of the bamboo culm are stiffer and stronger than the fibers of most wood species, so that boards incorporating bamboo could have a much higher strength to weight ratio than boards made from other types of wood fibers.

Composite Panels Formed With Bamboo and Wood Components

The first step in the preparation of the bamboo materials to be used in the formation of wood composite panels according to example embodiments of the present invention is to cut the bamboo into strands. Preferably, the bamboo strands are cut into thicknesses of less than about 0.2 inches, such as less than 0.15 inches, such in the range of about 0.01 inches to about 0.15 inches; and cut the bamboo into widths of preferably greater than 0.1 inches, such as more than 0.15 inches, such as more than 0.5 inches. Alternatively, the bamboo can be cut along the entire length of the bamboo trunk (a distance typically between about 4 feet to about 40 feet). This cutting may be done either manually or with mechanized clipping equipment. In preferred example embodiments, the bamboo strands are cut along the longitudinal axis of the bamboo trunk into strands preferably longer than about 2 inches, such as about 3 inches, such as about 5 inches or more. It is believed that the longer the strip length the more closely aligned adjacent strands of bamboo are oriented when using a disk strand orienter. Additionally, it is believed that the more closely aligned strands will result in a final wood composite product that has an improved modulus of elasticity along the longitudinal axis of the product.

In a first set of example embodiments, the strips are woven together (either manually or mechanized) to form woven bamboo sheets. The sheets are then coated with a resin, such as an isocyanate resin. Preferably the isocyanates are selected from the diphenylmethane-p,p′-diisocyanate group of polymers, which have NCO— functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is RUBINATE® 1840 available from Huntsman, Salt Lake City, Utah, and MONDUR® 541 available from Bayer Corporation, North America, of Pittsburgh, Pa. Also suitable for use are phenol formaldehyde (“PF”), melamine formaldehyde, melamine urea formaldehyde (“MUF”) and the co-polymers thereof. Suitable commercial MUF binders are the LS 2358 and LS 2250 products from the Dynea Corporation.

The resin concentration will be from about 2 wt % to about 12 wt %, based on the dry weight of the bamboo sheet. After being coated with the resin, the bamboo sheets may optionally be allowed to dry. The drying can be done at ambient temperature or using a kiln, although if a kiln is used, it must be set to a low temperature that does not initiate cure of the resin. The sheets are used either singly or in combination with other bamboo sheets to form one or more bamboo layers placed on top of a composite wood piece, as is described in greater detail below with respect to the primary and secondary process of manufacture.

Preferably, the wood composite component is made from OSB material. The oriented strand board is derived from a starting material that is naturally occurring hard or soft woods, singularly or mixed, whether such wood is dry (having a moisture content of between about 2 wt % and about 12 wt %) or green (having a moisture content of between about 30 wt % and about 200 wt %). In preferred example embodiments, the raw wood starting materials are pine and aspen wood, either alone or in combination. Other suitable soft and hard wood species include, but are not limited to, cedar, fir, oak, maple and other commonly used species. Typically, the raw wood starting materials, either virgin or reclaimed, are cut into strands, wafers or flakes of desired size and shape, which are well known to one of ordinary skill in the art. For example, the strands of woods may be cut to a substantially similar size and shape as the bamboo strands.

After the wood strands are cut, they are dried in an oven and then coated with a special formulation of one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, although a preferred technique is to spray the wax, resin and other additives upon the wood strands as the strands are tumbled in a drum blender.

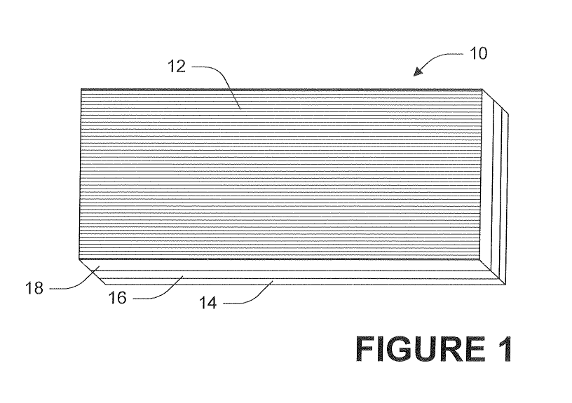

After being coated and treated with the desired coating and treatment chemicals, these coated strands are used to form a multi-layered mat 10, preferably a three layered mat which is then pressed to form a composite wood component as generally shown in FIG. 1. This layering may be done in the following fashion. The coated wood flakes 12 are spread on a conveyor belt to provide a first ply or layer 14 having flakes oriented substantially in line, or parallel, to the conveyor belt, then a second ply 16 is deposited on the first ply, with the flakes of the second ply oriented substantially perpendicular to the conveyor belt. Finally, a third ply 18 having flakes oriented substantially in line with the conveyor belt, similar to the first ply 14, is deposited on the second ply 16 such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plies are surface layers, while the second ply is a core layer. The surface layers each have an exterior face.

The above example may also be done in different relative directions, so that the first ply has flakes oriented substantially perpendicular to the conveyor belt, then a second ply is deposited on the first ply, with the flakes of the second ply oriented substantially parallel to the conveyor belt. In the present invention, the longitudinal edges of the board are formed parallel to the conveyor belt, so that flakes oriented substantially parallel to the conveyor belt will be oriented substantially parallel to the conveyor belt will end up being substantially parallel to the longitudinal edges of the final wood panel product. Finally, a third ply having flakes oriented substantially perpendicular with the conveyor belt, similar to the first ply, is deposited on the second ply.

Various polymeric resins, preferably thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates are the preferred binders, and preferably the isocyanates are selected from the diphenylmethane-p,p′-diisocyanate group of polymers, which have NCO— functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is RUBINATE® 1840 available from Huntsman, Salt Lake City, Utah, and MONDUR® 541 available from Bayer Corporation, North America, of Pittsburgh, Pa. Suitable commercial MUF binders are the LS 2358 and LS 2250 products from the Dynea Corporation.

The binder concentration is preferably in the range of about 2 wt % to about 15 wt %. A wax additive is commonly employed to enhance the resistance of the OSB panels to moisture penetration. Preferred waxes are slack wax or an emulsion wax. The wax solids loading level is preferably in the range of about 0.1 wt % to about 3.0 wt % (based on the weight of the wood).

After the multi-layered mats are formed according to the process discussed above, they are compressed under a hot press machine that fuses and binds together the wood materials, binder, and other additives to form consolidated OSB panels of various thickness and sizes. The high temperature also acts to cure the binder material. Preferably, the panels of the invention are pressed for 2-15 minutes at a temperature of about 175° C. to about 240° C. The resulting composite panels will have a density in the range of about 35 lbs/ft³ to about 48 lbs/ft³ (as measured by ASTM standard D1037-98). The density ranges from 40 lbs/ft³ to 48 lbs/ft³ for southern pine, and 35 lbs lbs/ft³ to 42 lbs/ft³ for Aspen. The thickness of the OSB panels will be from about 0.6 cm (about ¼″) to about 5 cm (about 2″), such as about 1.25 cm to about 6 cm, such as about 2.8 cm to about 3.8 cm.

Next, the final wood panel (bamboo/wood composite panel) is produced using either a primary or secondary process. In the primary process, the one or more woven bamboo layers are placed onto the conveyor belt first before the coated wood flakes (see above), then the wood flakes are arranged on top of the woven bamboo layers, and then a second set of woven bamboo layers are placed on top of the wood flakes. This unconsolidated structure is then passed into a hot press and consolidated using heat and pressure with the resin coating on the flakes and the bamboo layers providing the adhesive bond. A primary process suitable for use in the present invention is described in U.S. Pat. No. 6,737,155.

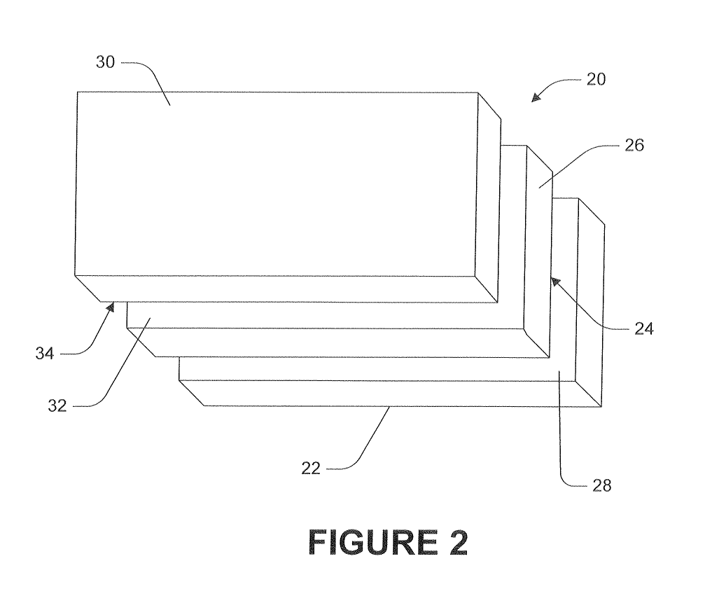

As an alternative to the primary process, a secondary process could be used. In the secondary process, the wood composite component and the bamboo layers are attached to each other to form a composite panel 20 as seen in FIG. 2. The attachment occurs such as by adhesively bonding the bamboo layers to the exterior faces of the surface layers of the wood composite component, such as by lamination. As seen in FIG. 2, this is done by placing a first woven bamboo layer 22 so that the lower surface 24 of the wood composite panel 26 contacts the upper surface 28 of the first woven bamboo layer 22. Next, a second woven bamboo layer 30 is placed on the upper surface 32 of the wood composite panel 26, such that the lower surface 34 of the second woven bamboo layer is in contact with the upper surface of the wood composite panel. The resin coating on the woven bamboo sheets (22, 30) provides adhesive attachment between the woven bamboo sheets and the surface layers of the wood composite component 26. The conveyor then transfers this bamboo-wood composite-bamboo mat into a press where heat and pressure are applied to consolidate the layers into a single composite structure panel 20.

Additionally, the wood panels may also be formed according to a second set of example embodiments. In such embodiments, the wood panels include not one, but two wood composite components. In this structure, there are successive alterations of bamboo layers, followed by the wood composite component, followed by the bamboo layers, followed by the wood composite component, followed by the bamboo layers. Regardless of which process or structure is chosen, the thickness of the bamboo layers will be from about 0.0625 inches to about 0.5 inches.

In a third set of example embodiments, the bamboo is mixed directly with strands cut from naturally occurring hard or soft woods, singularly or mixed, whether such wood is dry (having a moisture content of between about 2 wt % and about 12 wt %) or green (having a moisture content of between about 30 wt % and about 200 wt %). Suitable soft and hard wood species used in this set of example embodiments include cedar, pine, fir, aspen, oak, maple, and other species as well. In preferred example embodiments, bamboo strands are directly mixed with pine and/or aspen wood. Typically, the raw wood starting materials, either virgin or reclaimed, are cut into strands, wafers or flakes of desired size and shape, which are well known to one of ordinary skill in the art. The bamboo strands and the hard/soft wood strands are each separately dried and coated with polymer resin binder, and then after the separate coating stages the coated hard/soft wood strands and coated bamboo strands are mixed together.

The binder resin and the other various additives that are applied to the wood/bamboo materials are referred to herein as a coating, even though the binder and additives may be in the form of small particles, such as atomized particles or solid particles, which do not form a continuous coating upon the wood/bamboo material. Conventionally, the binder, wax, and other additives are applied to the wood/bamboo materials by one or more spraying, blending or mixing techniques, a preferred technique is to spray the wax, resin, fungicide and other additives upon the wood/bamboo strands as the strands are tumbled in a drum blender.

After being coated and treated with the desired coating and treatment chemicals, these coated strands of wood and bamboo are used to form a multi-layered mat, preferably a three layered mat which is then pressed to form a composite wood component. This layering may be done in the following fashion, which is similar to methods discussed above. The coated flakes (mixed wood and bamboo) are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. In the case of a three ply or three layered mat, the first and third plies are surface layers, while the second ply is a core layer. The surface layers each have an exterior face.

The above example may also be done in different relative directions, so that the first ply has flakes oriented substantially perpendicular to conveyor belt, then a second ply is deposited on the first ply, with the flakes of the second ply oriented substantially parallel to the conveyor belt. In the present invention, the longitudinal edge of the board is formed parallel to the conveyor belt, so that flakes oriented substantially parallel to the conveyor belt will be oriented substantially arranged substantially parallel to the conveyor belt, will end up being substantially parallel to the longitudinal edge of the final wood panel product. Finally, a third ply having flakes oriented substantially perpendicular with the conveyor belt, similar to the first ply, is deposited on the second ply.

An important aspect of such embodiments is the distribution of the bamboo strands throughout the wood panel. As discussed above, in example embodiments the bamboo strands are evenly distributed throughout the wood panel (i.e., located in all three plies). In alternative example embodiments, the bamboo strands may instead be located only in the surface layers. When the bamboo strands are located solely in the surface layers, they are there in order to affect the basic and novel properties of the surface layers such as strength and material weight.

After the multi-layered mats are formed according to the process discussed above, they are compressed under a hot press machine that fuses and binds together the wood materials, bamboo strands, binder, and other additives to form consolidated OSB panels of a desired thickness and sizes. The high temperature also acts to cure the binder material. Preferably, the panels of the invention are pressed for 2-15 minutes at a temperature of about 175° C. to about 240° C. The thickness of the OSB panels will be from about 0.6 cm (about ¼″) to about 5 cm (about 2″), such as about 1.25 cm to about 6 cm, such as about 2.8 cm to about 3.8 cm.

Examples of Composite Panels Formed From Bamboo and Wood Strands

Composite panels were made according to the present invention as follows. Bamboo strands were cut on a CAE disk flaker to an approximate size of 0.032 inch by 3 inches by 6 inches. Pine flakes were made under normal stranding conditions to an approximate size of 0.032 inch by 3 inches by 5 inches. The strands were then mixed together in ratios of 75:25, 50:50, and 25:75 of pine to bamboo (see Table 1, below). In the tables below it is noted as to whether the bamboo is distributed throughout the material, or whether the bamboo strands are found in the surface layers only. In all cases, the core constituted 40% of the weight of the composite panel, while the surface layers constituted 60%. A resin concentration of 5 wt % MDI was used along with the wax concentration being 1.5%. The panels were pressed at 400° F. for 175 seconds at 200+PSI to a target density of 44 pcf and a target thickness of ¾ inch thick.

The panels were then tested for several different wood composite performance characteristics according to the protocol specified in ASTM D1037. These performance characteristics included Modulus of Elasticity (“MOE”, a measure of panel stiffness) in both the parallel and the perpendicular directions (with the results then averaged); Modulus of Rupture (“MOR”, a measure of panel strength) in both the parallel and the perpendicular directions (again, the results were then averaged); 1 inch thickness swell, and edge swell.

The results were as follows:

TABLE 1

| Ratio: | Thickness | Edge |
|---|---|---|
| Pine/Bamboo | Swell (at 1 inch) | Swell |
| 100/0 | 5.2 | 9.2 |
| 75/25 | 5.4 | 9.8 |
| 50/50 | 4.1 | 8.4 |
| 25/75 | 3.8 | 7.3 |
| 0/100 | 8.3 | 11.3 |

As can be seen in Table 1, the addition of pine greatly reduced the amount of swelling that an all-bamboo panel showed. In fact, the best performance was obtained when a more even mixture of pine and bamboo strands was used. The measurements obtained were somewhat different depending on whether they were made at the edge or at a distance of 1 inch from the edge, toward the interior of the sample as required by ASTM D1037, but for both measurement methods the overall trend was exactly identical.

TABLE 2
(Average MOE of Samples)

| | Bamboo Strands | |
|---|---|---|
| Ratio: | Distributed Throughout | Bamboo Only In Surface |
| Pine/Bamboo | Material | Layers |
| 100/0 | 848307 | 848307 |
| 75/25 | 896859 | 876046 |
| 50/50 | 935900 | 917397 |
| 25/75 | 1109851 | 1034548 |
| 0/100 | 1117454 | N/A |

TABLE 3
(Average MOR of Samples)

| | Bamboo Strands | |
|---|---|---|
| Ratio: | Distributed Throughout | Bamboo Only In Surface |
| Pine/Bamboo | Material | Layers |
| 100/0 | 5625 | 5625 |
| 75/25 | 3990 | 4351 |
| 50/50 | 6070 | 6503 |
| 25/75 | 6891 | 6538 |
| 0/100 | 7923 | N/A |

As can be seen in Tables 2 and 3, the addition of bamboo to form a panel made of a blend of bamboo and pine strands significantly improves the strength of the panel compared to the strength of a panel that is 100% pine. This was true when strength was measured both by MOE and MOR.

It is important to note that in all example embodiments disclosed herein the bamboo/wood composite panels of the present invention are generally rectangular planes (or substantially planar), having two sets of substantially parallel edges. The panels according to the present invention vary in thickness from about 0.25 inches thick to about 2.0 inches thick—although each individual panel is of substantially uniform thickness. In addition, although each panel is formed from numerous strips/flakes of bamboo and/or wood, each completed panel is a single unitary component (such as an OSB panel, etc.). Specific commercial embodiments of panels according to the present invention have panel dimensions of 4 feet by 8 feet (plus or minus about 1 inch to account for margin of error in manufacturing—wherein a commercial panel having panel dimensions of 4 feet by 8 feet can in actuality extend from 3 feet 11 inches to 4 feet 1 inch by 7 feet 11 inches to 8 feet 1 inch). Other commercial embodiments of the present invention yield panels having dimensions of about 4 feet by about 10 feet, about 4 feet by about 16 feet, and about 8 feet by about 16 feet. The thinnest panels formed according to example embodiments disclosed herein could be used, e.g., as web stock for engineered wood I-joists. The panels of intermediate thickness could be used as sheathing and sub flooring. The thickest panels could be used for millwork applications. Another use for the panels formed according to example embodiments disclosed herein could be as shipping containers and decking material for transportation trailers.

Embodiments Containing Fungal and Insect Repellants

In additional example embodiments of the present invention, the composite panels can be formed from natural and/or man-made components that repel insects and/or fungus. As used herein, “fungus” refers to a large and diverse group of eukaryotic microorganisms whose cells contain a nucleus, vacuoles, and mitochondria. Fungi include algae, molds, yeasts, mushrooms, and slime molds. See, Biology of Microorganisms, T. Brock and M. Madigan, 6th Ed., 1991, Prentice Hill (Englewood Cliffs, N.J.). Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

In one such example embodiment, bamboo strands are dried in an oven and then mixed with cedar wood strands. The strands are mixed together in a proportion of about 25 wt % to about 75 wt % cedar wood and about 25 wt % to about 75 wt % bamboo (all of these weight fractions are based on the dry weight of the wood strands alone, without additional additives). The bamboo and cedar strands are then both coated with, e.g., isocyanate resins. The isocyanate resin(s) and other various additives (as taught herein) are applied to the bamboo and cedar as a coating, even though the isocyanate resin and additives may be in the form of small particles, such as atomized particles or solid particles, which do not form a continuous coating upon the wood material. In a preferred example formulation, the isocyanates are applied at a concentration of about 2 wt % to about 12 wt % (based on the total weight of the lignocellulosic strands).

After being coated with resin, the coated bamboo and cedar strands are used to form a multi-layered mat, preferably a three layered mat which is then pressed to form a composite wood component. This layering may be done in the same fashion as described above for creating a multi-layered mat. After the multi-layered mats are formed, they are compressed together as described in detail above to fuse and bind the layers together (wood/bamboo materials, binder, other additives, etc.).

### Cedar Examples

Example embodiments of composite panels formed from the combination of cedar and bamboo will now be described in more detail with respect to the following, specific, non-limiting examples.

A strand composite board containing a mixture of bamboo and cedar strands was prepared as follows. Strands were cut from bamboo logs (in some cases the bamboo was soaked in water for 24 hours before stranding) in average dimensions of 0.025 inch thick by 2 inches wide, by 6 inches long. The bamboo strands were mixed in three separate ratios (see Table 4, below) with cedar strands. The cedar strands had average dimensions of 0.032 inch thick by 3 inches wide by 5 inches long. MDI resin was applied at a concentration of about 5 wt %, with an application of about 1.5 wt % slack wax.

Strand composite panels were prepared with 60% of the strands lying in the surface layers, and 40% of strands in the core layer, wherein the strands in the core and the strands in the surface layers have substantially perpendicular orientations. Three sets of panels were made with three different blends of cedar and bamboo strands as set forth in Table 4 below. The panels were prepared by pressing the strands at a temperature of 400° F. for 175 seconds at a pressure of 200 psi or greater to a ¾ inch target thickness with a target density of 44 pcf.

For each made, the MOE and MOR was tested and measured (according to ASTM standard D1037-98), and the results averaged for each individual set. The results are set forth below in Table 4, below.

TABLE 4

| | 75% Cedar | 50% Cedar | 25% Cedar |
|---|---|---|---|
| | 25% Bamboo | 50% Bamboo | 75% Bamboo |
| MOE (psi) | 530,000 | 840,000 | 935,000 |
| MOR (psi) | 2,400 | 5,700 | 4,800 |

The tests results show that the panels with the higher fraction of strands taken from bamboo had higher strength than those with a higher cedar strand fraction. Nonetheless, all of the panels showed at least satisfactory performance for use in structural applications.

Resistance to fungal attack was measured according to NWWDA TM1 test method. The weight loss of ¾″ cubes due to fungal attack was measured over a 16 week test period. For this particular study, the brown rot fungus Gleophyllum trabeum was used to attack the samples, as this fungus is known to aggressively attack bamboo. Samples of 100% wood weight bamboo OSB showed a weight loss average of 21% over the 16 week test. Samples of 100% cedar showed a weight loss average of 8.7%, which represents the maximum benefit achievable when using cedar. When 25 to 75% cedar by wood weight was added to OSB containing bamboo, the weight loss was between 13% and 18%, which gives a benefit of 25 to 65% of the maximum benefit.

In other example embodiments, boron compounds are added to the bamboo strands to introduce fungicidal properties to a composite panel. For instance, in example embodiments, the bamboo composite panel is prepared by adding a boron compound fungicide during the blending and mixing stages (discussed in greater detail below) so that the fungicide fully penetrates into the strands. In preferred example embodiments, zinc borate is used to impart fungicidal properties to the composite panel. Zinc borate has shown itself to be effective not only against fungus like white and brown rot, but also against insects like termites. Moreover zinc borate is water-insoluble, which means that it not only does not bleed out of bamboo when the bamboo is contacted by water, but also means that the zinc borate is compatible with a wider range of resins (discussed below) than water-soluble fungicides.

The boron compounds used in conjunction with example embodiments of the present invention are particulates, preferably small enough to pass through a 30 size mesh screen. Zinc borate is the preferred boron compound but also acceptable are more general anhydrous borax compounds. The boron compound is preferably used at a concentration of about 0.25 wt % to about 1.25 wt %.

### Boron Based Fungicide Examples

OSB panels of the type having a composite wood core and multi-layered bamboo mats adhered to the core with a target thickness of ¾″ and a target density of 46 pcf were prepared with Mondur® G541 pMDI resin at a concentration of 5 wt % (based on the weight of the wood flakes), wax at a concentration of 2.5 wt %, and with zinc borate added during blending at concentrations of 0.0 wt %, 0.25 wt %, 0.5 wt %, 1 wt % and 1.25 wt % (again based on the weight of the wood flakes).

Cubes were then cut from these panels and then tested for fungal resistance according to the test WDMA/NWWDA TM 1 test protocol. In this test, the OSB samples were exposed to the brown rot decay fungus (Gloeophyllum trabeum) and the white rot fungus (Trametes versicolor) under ideal fungal growing conditions for twelve weeks. Before testing, some of the cubes were “weathered” according to Window and Door Standard NWWDA-TM-1 (“Soil Block Test”), while others were not weathered. After exposure is completed the samples are removed and are weighed to determine the percentage of weight loss due to decay. The amount of weight loss is set forth in Table 5 below.

TABLE 5

| % Zinc Borate | Fungus Type | Weathered | % Weight Loss |
|---|---|---|---|
| 0.0 | brown | Y | 21.28 |
| 0.25 | brown | Y | 6.60 |
| 0.5 | brown | Y | 2.19 |
| 0.75 | brown | Y | 1.99 |
| 1.0 | brown | Y | 2.66 |
| 1.25 | brown | Y | 2.74 |
| 0.0 | brown | N | 17.24 |
| 0.25 | brown | N | 5.53 |
| 0.5 | brown | N | 2.32 |
| 0.75 | brown | N | 1.91 |
| 1.0 | brown | N | 3.1 |
| 1.25 | brown | N | 2.31 |
| 0.0 | white | Y | 25.9 |
| 0.25 | white | Y | 2.56 |
| 0.5 | white | Y | 3.38 |
| 0.75 | white | Y | 3.13 |
| 1.0 | white | Y | 3.6 |
| 1.25 | white | Y | 2.84 |
| 0.0 | white | N | 34.06 |
| 0.25 | white | N | 2.35 |
| 0.5 | white | N | 1.37 |
| 0.75 | white | N | 1.38 |
| 1.0 | white | N | 2.9 |
| 1.25 | white | N | 2.4 |

As can be seen in Table 5, the amount of bamboo panel lost to rot declined dramatically when zinc borate was included in the bamboo panel as described above. This indicates that zinc borates provide excellent fungicide performance.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. In a substantially 4 foot by 8 foot composite wood panel having a thickness of between about 0.25 inches and about 2 inches, being formed from flakes of compressed wood and having a top surface and a bottom surface, the improvement comprising:
an upper surface layer attached to the top surface of the composite wood panel, the upper surface layer being formed from one or more plies of bamboo strands and having a thickness of about 0.0625 inches to about 0.5 inches; and
a lower surface layer attached to the bottom surface of the composite wood panel, the bottom surface layer being formed from one or more plies of bamboo strands and having a thickness of about 0.0625 inches to about 0.5 inches.

2. The improvement of claim 1, wherein the strands of bamboo are taken from the outer culm of a bamboo plant.

3. The improvement of claim 1, wherein the strands of bamboo are taken from the inner culm of a bamboo plant.

4. The improvement of claim 1, wherein the composite wood panel includes between about 25% to about 75% bamboo strands and between about 75% and about 25% wood strands.

5. The improvement of claim 4, wherein the wood strands are selected from the group comprising cedar, pine, fir, aspen, oak, and/or maple.

6-8. (canceled)

9. A multi-layered composite panel comprising:
a first ply of bamboo flakes being substantially oriented in a first direction;
a second ply of wood flakes being substantially oriented in a second direction substantially perpendicular to the first direction, the second ply of wood flakes resting on top of the first ply; and
a third ply of bamboo flakes being substantially oriented in the first direction, the third ply of bamboo flakes resting on top of the second ply;
wherein the first, second and third plies are coated in one or more polymeric resins to serve as a binder, the binder being in the range of about 2 wt % to about 15 wt %.

10. The multi-layered composite panel of claim 9, wherein the first ply of bamboo flakes and third ply of bamboo flakes are taken from the outer culm of one or more bamboo plants.

11. The multi-layered composite panel of claim 9, wherein the first ply of bamboo flakes and third ply of bamboo flakes are taken from the inner culm of one or more bamboo plants.

12. The multi-layered composite panel of claim 9, wherein the first ply of bamboo flakes and third ply of bamboo flakes are taken from both the inner and outer culm of one or more bamboo plants.

13. The multi-layered composite panel of claim 9, wherein the first and third plies further include wood flakes.

14. The multi-layered composite panel of claim 13, wherein the second ply further includes bamboo flakes.

15. (canceled)

16. A multi-layered composite wood panel comprising:
a core layer formed from aspen or pine wood flakes, the core layer having a top surface and a bottom surface;
a first surface layer adhered to the top surface of the core layer, the first surface layer including strands of woven bamboo; and
a second surface layer adhered to the bottom surface of the core layer, the second surface layer including strands of woven bamboo;
wherein the core layer, first surface layer, and second surface layer are bound together to form a substantially rectangular plane having a thickness of between about 0.25 inches and about 2.0 inches.
